(19) United States
(12) Patent Application Publication
(10) Pub. No.: US 2007/0017978 A1
(43) Pub. Date: Jan. 25, 2007

(54) Device for dispensing a determined number of pre-printed tickets, such as lottery tickets

(76) Inventor: Bao Quoc Ho, Champs Sur Marne (FR)

Correspondence Address: OSHA LIANG L.L.P., 1221 MCKINNEY STREET, SUITE 2800, HOUSTON, TX, 77010, US

(21) Appl. No.: 10/575,936

(22) PCT Filed: Oct. 8, 2004
(86) PCT No.: PCT/FR04/02539

§ 371 Date: Apr. 13, 2006

(30) Foreign Application Priority Data
Oct. 14, 2003 (FR) 0311975

(51) Int. Cl. G06F 7/08

(52) U.S. Cl. 235/381

(57) ABSTRACT

A device for dispensing a strip of pre-printed tickets, said strip including a plurality of score lines defining successive tickets. The device includes a stepping motor which is used to convey the strip towards a theoretical cutting position using a determined number of motor steps corresponding to the number of tickets required. The aforementioned stepping motor is associated with adjustment means which are used, if necessary, to adjust the position from the strip from the theoretical cutting position to a correct cutting position. The adjustment means includes a first memory means which stores the individual length of the tickets by counting the corresponding number of steps of the motor, a second memory means which stores a characteristic motif of the tickets, and a recognition means which recognizes the passing of the motif as the strip is conveyed to the theoretical cutting position.

The present invention is from the area of machinery to produce pre-printed tickets formatted in a strip and, more specifically, has the objective of providing a device for dispensing a determined number of such tickets, such as lottery tickets.

One is familiar with machinery that is intended to dispense pre-printed tickets, particularly lottery tickets. Such machinery is equipped with a keyboarding console associated with means of payment for the selective delivery of a determined number of tickets corresponding to a game chosen by the user from among a plurality of games at his disposal. The tickets are formatted in strips that are housed in the machine inside respective storage reserves, two adjoining tickets being separated from one another by a scored line on the strip.

Prior to using the machine, a ticket at the end of the strip is introduced by an operator into a device for routing and separating the tickets by means of an entry admitter that includes this device. The strip is routed by automated rollers from the admitter toward a cutter to separate the tickets from the strip for delivery along a corresponding scored line. Then the tickets that are separated from the strip are routed toward an exit opening for their withdrawal by the user.

Means of detection permit counting the number of tickets to be routed toward the cutter and placing the scored line of the strip in correlation with it. These operations are specifically achieved by means of an optic detecting sensor of a reference mark that is included on the tickets, this reference mark consisting of, for example, scoring lines or marks arranged on both sides of the latter.

For familiarity with a technological environment close to the present invention, one can, for example, refer to W09949418 (TICKET DISPENSERS PTY LTD) and AU5071093 (BROWN).

One difficulty to be overcome resides in the rigorous relative positioning of the scoring lines in relation to the cutter, especially since the tickets are susceptible of presenting a flatness defect due to external conditions, notably humidity and/or heat. Such a possibly deficient positioning provokes a shift between the cut line of the strip and the scored line that separates the tickets that are to be dispensed and the following ticket, with, as a consequence, a risk of changing the integrity of the tickets that are delivered and therefore their validity.

The goal of the present invention is to propose a device for routing and separating pre-printed tickets formatted in a strip that allows delivery of honest tickets in a number exactly corresponding to the one required by the user, starting, notably, with positioning the strip in relation to the cutter that should exactingly guarantee correct cuts of the strip along the corresponding scoring line, even despite a possible flatness defect in the latter.

The inventive procedure in the present invention consisted in placing the routing of the strip toward the cutter depending first on a means of conveying the strip toward a theoretical cutting position with regard to a determined number of tickets to be delivered, then, if necessary, on a second means of conveying the strip to adjust its position from the theoretical cutting position toward a correct cutting position in which the scored line that is to be cut is exactly opposite the cutter.

More precisely, the conveyance of the strip is achieved by the intermediary of a stepping motor to initially pull the strip toward the theoretical cutting position following a number of steps of the motor corresponding to the length of the strip that exactly corresponds to the number of tickets that are to be dispensed. During this routing, the scrolling of a motif on at least a portion of the ticket is detected by optic means to verify the concordance between the theoretical cutting position and the correct cutting position.

This verification is accomplished by recognizing the integrity of the motif that has filed by, if necessary setting the stepping motor in motion and adjusting the position of the strip in correct cutting position.

One will note that these arrangements not only permit barring a defective interrelationship between the number of tickets required and the number of tickets dispensed, via a specific counting operation, but also by placing the corresponding scoring line exactly opposite the cutter, no matter what number of tickets are dispensed or of what possible flatness defect the strip is susceptible to alter its appropriate position in relation to the cutter. One will note that a previous stage of initialization permits memorizing, on the one hand, the length of a ticket from the strip to set the stepping motor in motion to a step number according to this length and the number of tickets to be dispensed, and, on the other hand, a sequence of marks that together form the motif for subsequent recognition of the latter at the time the strip scrolls by.

Otherwise, from the scored line being placed exactly opposite the cutter, it is proposed by the present invention and according to another of its aspects, to associate a mobile press with the cutter, preferably constructed of a guillotine blade or the like to flatten the strip against a table prior to its cutting, preferably on both sides of the blade. One will note that the means of mobility of the press are advantageously situated depending on the means of mobility of the guillotine blade to trigger cutting the strip from the moment the latter is firmly maintained in its plane.

Besides, and to encourage a plane routing of the strip, it is proposed by the present invention to organize the admitter entry of the device in a hopper to constrain the strip in its general plane prior to its being swallowed by the conveyor rollers.

One will note the advantageous complementarity of the two aforementioned aspects of the present invention that encourage an honest delivery of the tickets beyond the advantages that each of these two aspects procures, namely for the first one a numbering and exact positioning independently of the scored line in relation to the cutter, and, namely for the second one maintenance of the strip in its general plane and reliable cutting of the latter that is taken into a vise between the press and the table prior to transfer of the guillotine blade orthogonally to the plane of the strip.

In general, the device of the present invention is a device for dispensing pre-printed tickets formatted as a strip with a plethora of scoring lines successively delimiting the tickets. This device comprises:
the means of request by a user for delivery of a set number of tickets, notably containing a keyboarding console and means of payment,
the means of conveyance of the strip of tickets from an admitter toward an exit opening that puts at least one set of automated opposing rollers in motion to convey the strip between them,
a cutting mechanism that mainly consists of a mobile cutter between a homing position and a cutoff position for the strip along one of its scoring lines,
the control mechanism for setting the roller motor and the cutter in motion, said control mechanism being in correspondence with the means for detecting the position of the strip in relation to the position of the cutter.

According to the present invention, such a device includes a stepping motor for conveyance by the rollers for routing the strip toward a theoretical cutting position following a determined number of steps of the motor corresponding to the number of tickets required. This stepping motor is, besides, associated with the means of adjusting the position of the strip, from the theoretical cutting position toward, if necessary, a correct cutting position.

These means of adjustment consist of the first means of memory of the individual length of the tickets starting with counting a number of corresponding steps of the motor, and of the second means of memory of a characteristic motif on the tickets.

These means of adjustment also consist of means of recognition of the scrolling of the motif at the time of the routing of the strip toward the theoretical cutting position.

One is to understand that the control mechanism that involves the device for the positioning of the belt motor of the rollers specifically consists of the first and second means of memory, and the means for recognizing the motif in relation to means of calculation relative to the correspondence between the length of the strip that is to be conveyed and the number of steps of the motor that are to be put in motion.

The motif is formed of a sequence of marks previously memorized by the second means of memory. The means of recognition associate a detection sensor of the scrolling of these marks and the means of comparison between, for example, the detected marks that file by and the previously memorized motif.

One will note that the means of recognition that are given as examples are preferred because of the advantage their simplicity procures, but that they are capable of being constituted by other analogous means of picture recognition without departing from the general rules of the invention that have been expressed.

The cutter is advantageously a guillotine blade associated with a mobile press between the homing position, in which the strip is free, and the cutting position in which the press maintains the strip applied against an opposing table.

The mobilities of the press and the blade are preferably subjugated in relation to each other to provoke application of the strip against the table prior to cutting the ticket. One is to understand that this subjection is capable of being achieved indifferently through the intermediary of the control mechanism and/or through the intermediary of means of mechanical linkages between the press and the blade. According to an advantageous example of realization of this subjection, the means of mobility of the press consist of an elastic or analogous component for spontaneous maintenance of the press against the table in opposition to its raising by the guillotine blade or in an analogous manner in opposition to its raising by means of the mobility of the latter.

The means of mobility of the guillotine blade are preferable to means of mobility by orthogonal transfer to the table's plane of rest, such as by setting a type of connecting rod-crank or analogous maneuverable component in motion.

Cutting with the blade is preferable to teeth for progressive cutting of full portions of the strip involving two successive weakenings of the scoring lines.

The admitter is advantageously arranged in a hopper or the like, forming a guide and plane maintenance for the strip of tickets toward the conveyor rollers. The hopper is preferably a pyramidal configuration and includes mobile lateral partitions to adjust the width of the hopper to the width of the strip.

An interactive games machine equipped with a device of the present invention includes a plurality of reserves of strips of specific tickets, to each of which are affected a delivery device. Moreover, the machine is equipped with means of collection and display, or even of impression.

According to a preferred shape of realization, such a machine is, moreover, advantageously equipped with means of interactive communication with a remote communications center for registration in this remote communications center of data relative to at least one game of chance selected by the user and for the registration and display of results of this game of chance from the remote communications center.

The present invention will be better understood, and some details will appear in noting the description that is going to be made of a preferred form of realization in relation to the figures of the attached drawings, in which

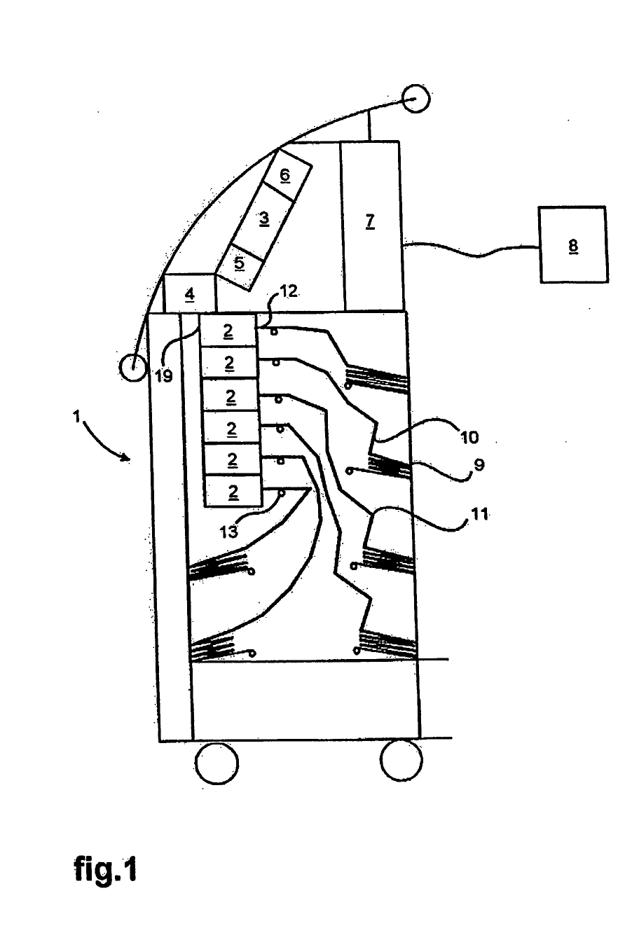

FIG. 1 is a schematic cutaway of a gaming machine equipped with a ticket dispensing device from the present invention.

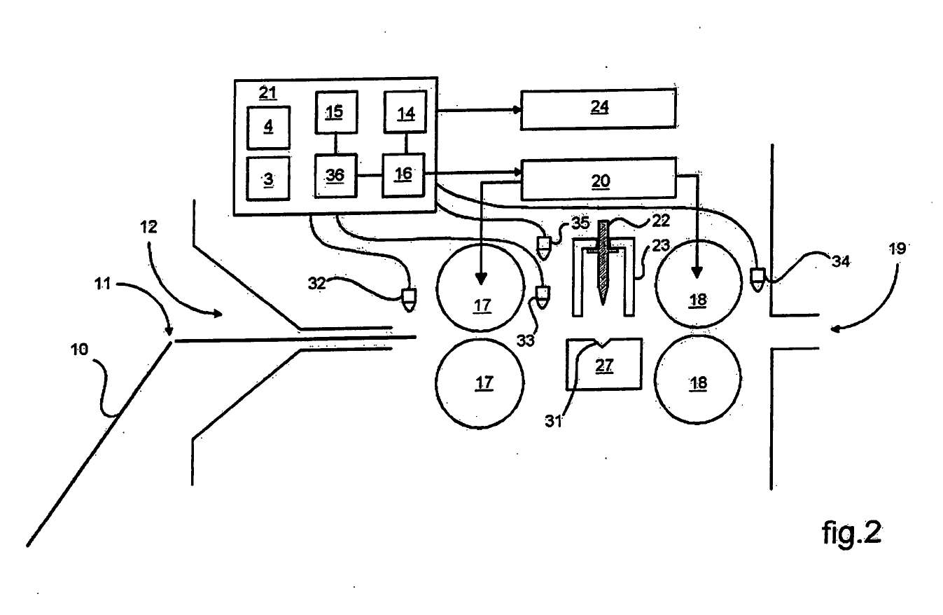

FIGS. 2 to 6 are schematic views successively illustrating different stages of implementation of a device of the invention according to one example of its realization.

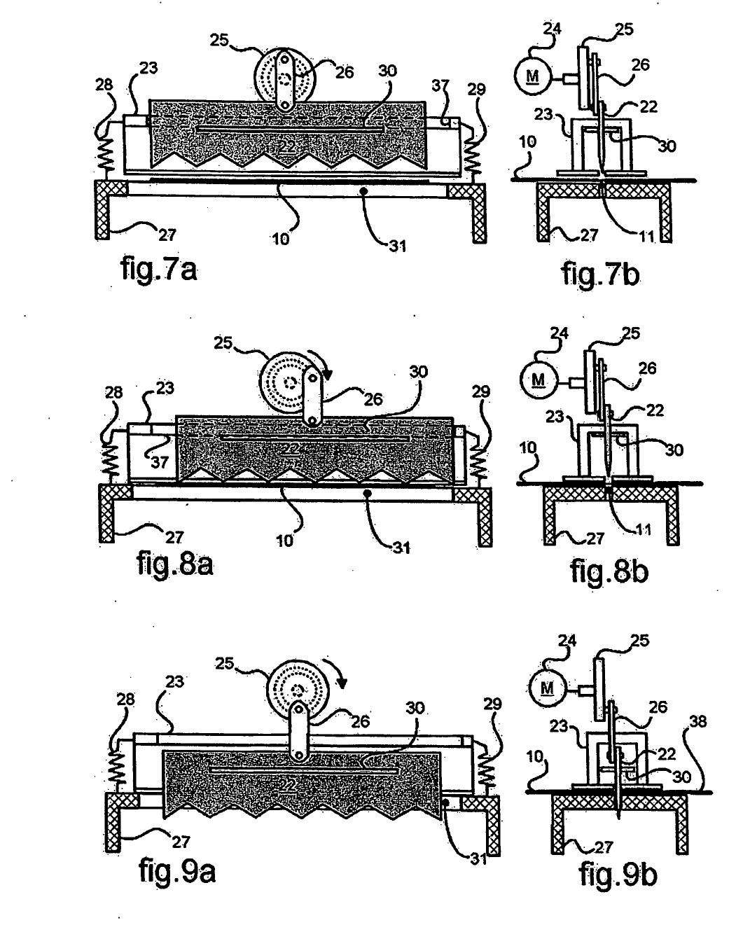

FIGS. 7 to 9 are diagrams illustrating implementation of a cutter with which the device of the invention represented in the previous figures is equipped, in which FIGS. 7a and 7b represent the cutter in homing position in a head-on and a side view respectively, while FIGS. 8a and 8b represent the cutter at the beginning of the cutting operation in a head-on and a side view respectively, and FIGS. 9a and 9b represent the cutter at the end of the cutting operation in a head-on and a side view respectively.

In FIG. 1, a game machine (1) is equipped with a plurality of devices (2) for dispensing pre-printed tickets, such as lottery tickets. The machine (1) includes a plurality of reserves, such as (9), of respective strips (10) of tickets, two adjoining tickets being separated from one another by a scored line (11).

At this stage of the description, one will note that, in a manner that is familiar from this domain, the tickets of a same strip (10) are identical while they are capable of presenting features that differ from one strip to another, notably, for example, with respect to the nature of the strip, the formation of the scoring lines, the geometric shape or the dimensional features of the tickets. One will also note that every ticket of a same strip (10) includes the same motif formed from a sequence of marks such as a bar code or the like, or even a picture.

In FIGS. 2 to 9, a device (2) for dispensing tickets consists of two sets of conveyor rollers (17,18) for a strip of tickets (10) in which an initial set (17) is placed in the vicinity of an admitter (12) and a second set (18) is placed in the vicinity of a dispenser exit (19) accessible to a user.

The rollers (17,18) are put in motion by a stepping motor (20) and drag the strip (10) between them by friction to route it (10) from the admitter (12) toward a cutter (22), and then toward the exit opening (19). One will note that the admitter (12) is arranged in a pyramidal hopper to form a guide rail and keep the strip (10) flat at the time of its introduction into the device (2).

The setting in motion of the rollers (17,18) and the cutter (22) respectively is subject to the control mechanism (21). The latter (21) is, on the one hand, connected to the optic sensors (32,33,34) to detect the presence and/or absence of the strip (10) in the various areas of the device (2), and, on the other hand, to an optic sensor (35) to detect the scrolling by of the motif on the tickets when the strip (10) is being conveyed toward the cutter (22) in order to place the scored line (11) that is to be cut opposite the latter (22).

A first sensor (32) is placed in the vicinity of the interior outlet of the admitter (12), between the latter (12) and the first set of conveyor rollers (17). A second sensor (33) and the other sensor (35) are aligned and are placed between the first set of conveyor rollers (17) and the press (23). One will note that the alignment of the one sensor (35) with the other sensor (33) is preferred, but that this position is capable of being relatively anywhere between the sensor (33) and the cutter (22), according to the position and the length of the motif on the tickets that is to be detected. A third sensor (34) is placed between the second pair of conveyor rollers (18) and the exit opening (19).

During the operation of loading the device (2), as illustrated in FIG. 2, the operator carries out the previous operations for memorization of, on the one hand, the length of an individual ticket of the loaded strip (10), and, on the other hand, of the motif that is to be detected through the intermediary of means of the first (14) and second (15) memory respectively that comprise the control mechanism (21).

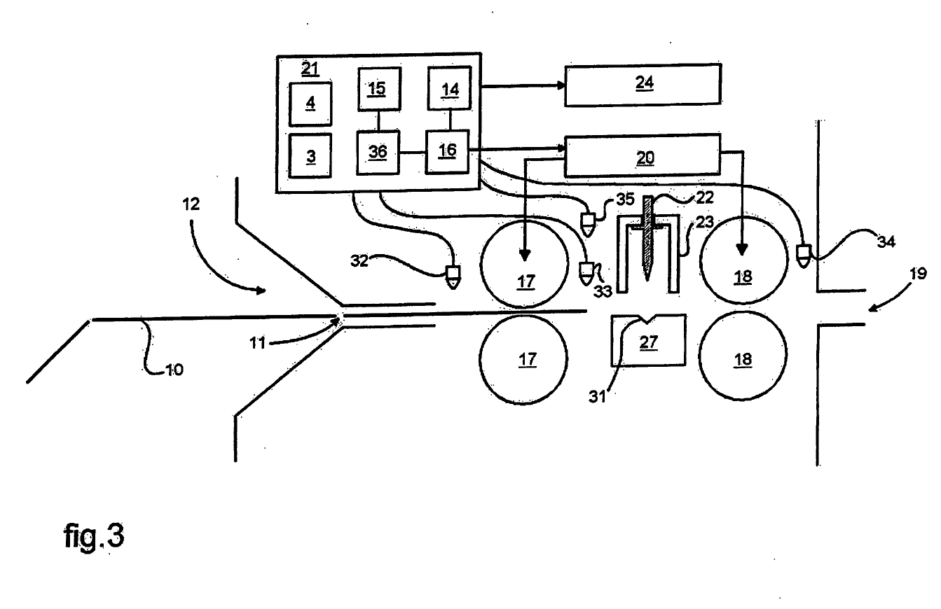

The first sensor (32) detects the presence of the strip (10) through the admitter (12), which triggers setting the rollers (17,18) in motion to route the strip (10) until the detection of its presence by the second sensor (33). This detection triggers stopping the rollers (17,18) and immobilization of the strip (10) that is then waiting for a request for tickets from a user, in the position illustrated in FIG. 3.

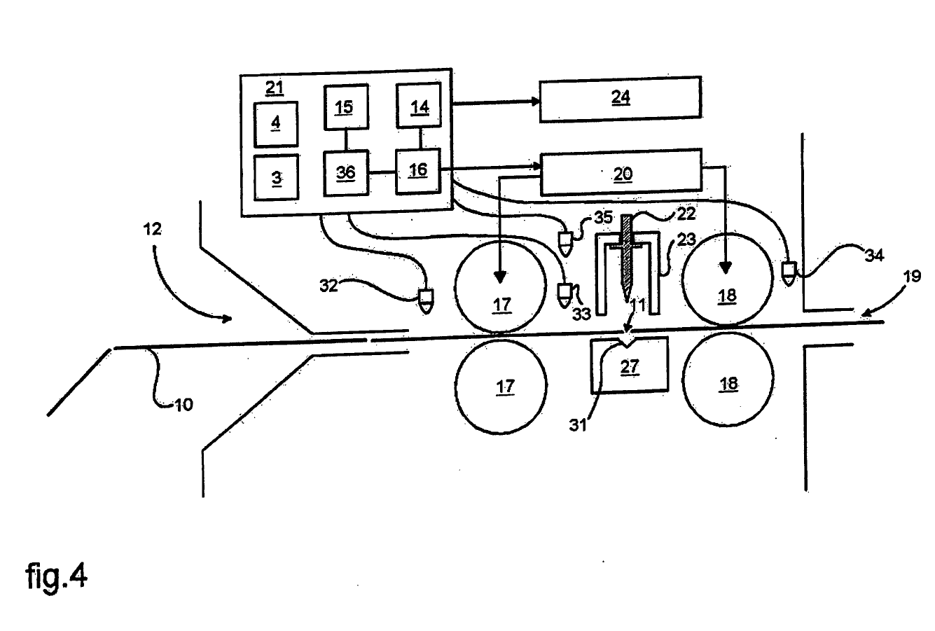

When the user requires delivery of a specific number of tickets through the intermediary of a keyboarding console (3) and means of payment (4) participating in the control mechanism (21), then the control mechanism (21) triggers setting the rollers (17,18) in motion to route the strip toward the cutter (22). This routing aims to place the cutter (22) opposite a scored line (11) of the strip (10) corresponding to the number of tickets required. This position of the strip (10) corresponds to a cutting position, as illustrated in FIG. 4. This routing is done by a set number of steps of the motor (20), according to the individual length of the pre-memorized reference from the tickets and the number of tickets required. One will note that the control mechanism (21) consists of a means of calculation (16) to determine the necessary number of steps of the motor (20).

It may happen, especially since the length of the strip (10) of tickets that is to be dispensed is significant, that the theoretical cutting position in which the strip (10) is placed does not exactly correspond to a position on the scored line (11) opposite the cutter (22) and that it is therefore necessary to adjust this theoretical cutting position of the strip (10) toward a correct cutting position as illustrated in FIGS. 5 and 7. For this, the control mechanism (21) also consists of a means of comparison (36) between the motif previously memorized by the second means of memory (15) and its scrolling or between the motifs detected by the sensor (35) at the time the strip (10) is routed to place it in theoretical cutting position. From this comparison and if it should be the case that the detected motif does not identically correspond to the one previously memorized, then the motor (20) for the conveyor rollers (17,18) is set in motion for the number of appropriate steps to adjust the position of the strip (10) in the correct cutting position.

More specifically, as in FIGS. 7 to 9, the cutter (22) is constituted of a guillotine blade in relation to a mobile press (23). The press (23) includes a passage (37) for the circulation of the blade (22) to its breadth, since the latter (22) is equipped with support components (30) for the press (23). The blade (22) and the press (23) are placed opposite an opposing table (27) against which the press (23) leans to maintain the strip (10) in a vise prior to its cutting. Some springs (28,29) are interposed between the press (23) and the table (27) to spontaneously trigger the lowering of the press (23) toward the table (27) in opposition to its support by the blade (22).

The blade (22) is mobilized by a motor component (24) and a mechanism associated with a connecting rod-crank (25,26) between a homing position, specifically illustrated in FIGS. 2 and 7, in which the blade (22) and the press (23) overhang the strip (10) and a cutting position in which the blade (22) slices the strip (10) as illustrated in FIGS. 5 and 9.

Once the strip of tickets (10) is placed in the correct cutting position, then the control mechanism (21) triggers setting the motor (24) in motion that maneuvers the guillotine blade (22) to drag the crank (25) in rotation and trigger the descent of the blade (22). This movement of the blade (22) releases a drive of the press (23) toward the table (27) subject to the effect of the springs (28 and 29). The blade (22) descends while sustaining the press (23) through the intermediary of support components (30) from the homing position until the press (23) is supported against the table (27) on both sides of the blade (22). More specifically, this support setting permits putting the strip (10) in a vise between the press (23) and the table (27) as illustrated in FIG. 8b.

Then, the blade (22) continues its descent to cut the scored line (11) between two adjoining tickets, while crossing the table (27) through a clearing (31) included in the table (27) as illustrated in FIGS. 9a and 9b. One will notice that the mobility of the blade through the intermediary of a connecting rod-crank device (25,26) also permits an inclined attack of the strip (10) by the cutting of the toothed blade (22).

When the strip (10) is cut, the blade (22) goes back up following the rotation of the crank (25), and in its ascending motion it lifts the press (23) to release the strip (10) and permit delivery of the tickets.

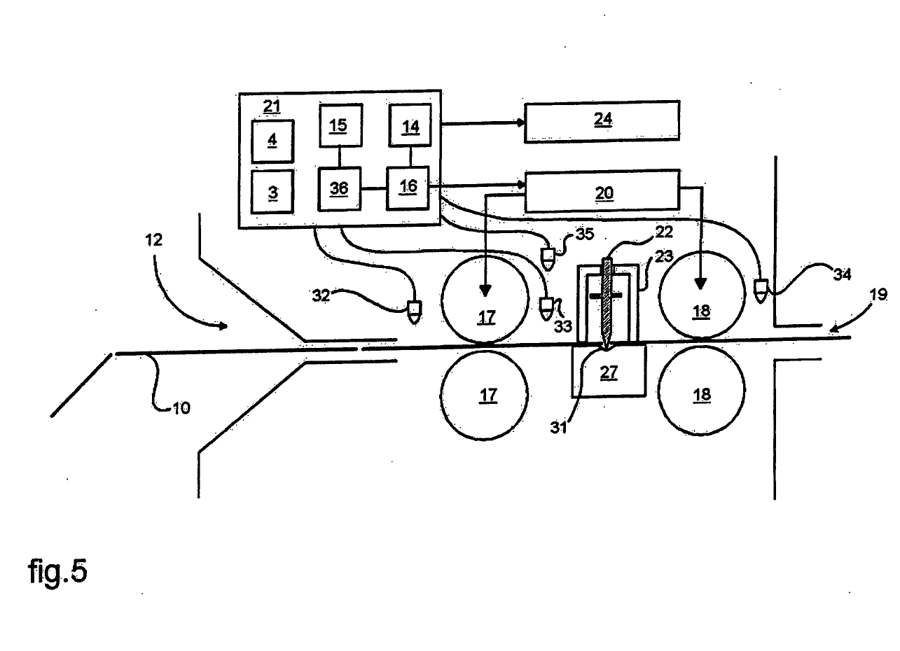

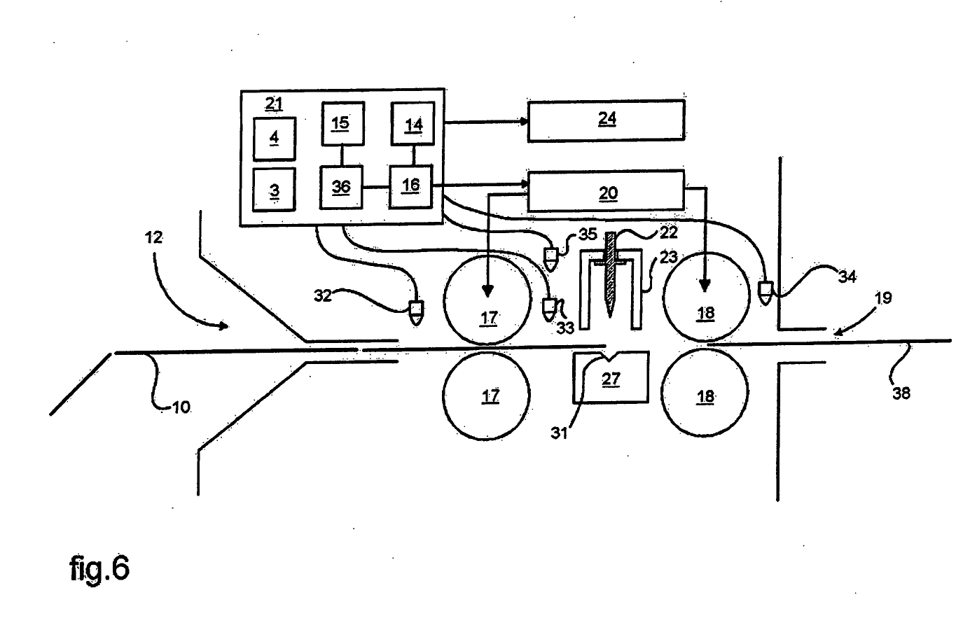

Once the tickets that are to be dispensed (38) are separated from the strip (10), the control mechanism (21) triggers setting the conveyor rollers (17,18) in motion to route the tickets that are to be dispensed (38) toward the exit opening (19) as illustrated in FIG. 6. Once the user has withdrawn the dispensed tickets (38), the sensor (34) detects their absence and the control mechanism (21) triggers setting the first conveyor rollers (17) in motion in the opposite direction to withdraw the strip (10) up to the second optic sensor (33) and to position the strip (10) in the position illustrated in FIG. 3, waiting for a new request for tickets.

Coming back to FIG. 1, one will also notice the presence of guide rollers (13) for the strips (10) from their respective reserve (9) toward the dispenser device (2) that is assigned to them.

Moreover, the gaming machine (1) is equipped with a keyboarding console (3), means of payment (4,) display screen (6) and means of imprinting (5), particularly of a receipt. This machine (1) also allows the user to participate in a telematic game of chance, selectable from among a plurality of available games, from the keyboarding console (3) and means of payment (4). Once the user has selected a game and attached the parameters of this game, they are memorized for their validation by the machine after payment of the appropriate sum by the user. The means of imprinting (5) permit editing a receipt for the user including data relating to the validated parameters of game and the appropriate payment. The machine also includes the means of telematic communication (7), such as a modem or the like, to transmit these data to a remote communications center (8), that on the one hand records the operations that are carried by the user and on the other hand transmits the results of the games to the machine (1).

One will note that the data display (6) not only permits visualizing information concerning the various operations carried out by the user, but also the results of telematic games from the remote communications center (8).

1. A device for dispensing pre-printed tickets formatted in a strip including a plurality of scoring lines successively delimiting the tickets, said device comprising:
means of request by a user for dispensing a pre-determined number of tickets,
means of conveying the strip of tickets from an admitter toward an exit opening, that sets at least one set of automated opposing rollers in motion to convey the strip between them,
a cutting mechanism that mainly consists of a cutting device moveable between a homing position and a cutting position on the strip along one of its scoring lines,
a stepping motor for conveyor rollers to route the strip toward a theoretical cutting position following a determined number of steps of the stepping motor corresponding to the number of tickets required,
a control mechanism for implementation of the stepping motor for the conveyor rollers and the cutting device, said control mechanism containing means of detection of a position of the strip in relation to a position of the mobile cutting device,
means for adjusting the position of the strip from the theoretical cutting position toward, if necessary, a correct cutting position, said means for adjusting containing an initial means of memory of the individual length of tickets starting from a count of the number of corresponding steps of the motor, wherein the means for adjusting additionally comprises a second means of memory of a characteristic motif on the tickets, as well as means of recognition of the characteristic motif scrolling by while the strip is being routed toward the theoretical cutting position, and by the fact that wherein the motif is formed by a sequence of marks, the means of recognition comprises a detection sensor for detecting the marks as they scroll by, and means of comparison for comparing the detected marks with the motif that was previously stored in the second means of memory.

2. A device according to claim 1, wherein the cutting device comprises a guillotine blade associated with a press moveable between the homing position, in which the strip is free, and the cutting position, in which the press keeps the strip in position against an opposing table.

3. A device according to claim 2, wherein the press and the blade move in a coordinated manner such that the strip is positioned against the table prior to cutting the ticket.

4. A device according to claim 3, wherein the press consists of an elastic component for maintaining the press against the table in opposition to its raising by the guillotine blade.

5. A device according to claim 1, wherein the guillotine blade is of the connecting rod-crank type.

6. A device according to claim 1, wherein cutting blade of the cutting device is toothed for progressive cuts of full portions of the strip included between two successive weakenings of the scoring lines.

7. A device according to claim 1 wherein the admitter is arranged as a hopper forming a guide rail and keeping the strip of tickets on flat plane toward the conveyor rollers.

8. A machine for interactive games equipped with a device for dispensing tickets according to claim 1, wherein the machine includes a plurality of reserves of strips of specific tickets, to each of which a delivery device is assigned.

9. A machine for interactive games according to claim 8, wherein the machine further comprises means for collection display and interactive communication with a remote communications center for registration with the remote communications center of data relating to at least one game of chance selected by the user and for registering and displaying results of the game of chance originating from the remote communications center.
